(19) United States
(12) Patent Application Publication
(10) Pub. No.: US 2010/0050399 A1
(43) Pub. Date: Mar. 4, 2010

(54) Active material based clamping apparatuses and methods of making

(75) Inventors: Alan L. Browne, Grosse Pointe, MI (US); Nancy L. Johnson, Northville, MI (US)

Correspondence Address: GENERAL MOTORS LLC;LEGAL STAFF, MAIL CODE 482-C23-B21, P O BOX 300, DETROIT, MI, 48265-3000, US

(73) Assignee: GM GLOAL TECHNOLOGY OPERATIONS , INC., DETROIT, MI (US)

(21) Appl. No.: 12/199,825

(22) Filed: Aug. 28, 2008

(51) Int. Cl. F16B 2/02; C22F 1/00

(52) U.S. Cl. 24/455; 148/563

(57) ABSTRACT

Active material based clamping apparatuses for securing objects and methods of making the same are provided. In an embodiment, a clamping apparatus for securing an object comprises: a clamp comprising an engaging surface for securing an object, wherein the engaging surface comprises an active material capable of undergoing a change in a property upon exposure to an activation source such that the active material conforms to a surface of the object.

### BACKGROUND

The present disclosure generally relates to clamps/grips, and more particularly, to active material based clamping apparatuses for securing objects and methods of making the same.

Various types of clamps or grips (clamps/grips) are currently employed in industry and at home to secure objects. Examples of such clamps/grips include hand tools such as pliers, wrenches, vice grips, C- or G-clamps, etc. Unfortunately, nonconformance and thus non-uniform pressure between the surface geometries of such clamps/grips and a gripped object can cause surface damage to the object. The gripping capability of the clamps/grips is also compromised by this nonconformance.

### BRIEF SUMMARY

Disclosed herein are active material based clamping apparatuses for securing objects and methods of making the same. In an embodiment, a clamping apparatus for securing an object comprises: a clamp comprising an engaging surface for securing an object, wherein the engaging surface comprises an active material capable of undergoing a change in a property upon exposure to an activation source such that the active material conforms to a surface of the object.

In another embodiment, a method of forming a clamping apparatus for securing an object comprises: applying an active material to an engaging surface of a clamp, wherein the active material is capable of undergoing a change in a property upon exposure to an activation source such that the active material conforms to the surface of the object.

In yet another embodiment, a clamping apparatus for securing an object comprises: a clamp comprising an engaging surface for securing an object, wherein the engaging surface comprises an active material capable of conforming to a surface of the object and undergoing an increase in hardness or stiffness upon exposure to an activation source such that the hold of the grip on the object is increased.

The above described and other features are exemplified by the following Figures and detailed description.

### BRIEF DESCRIPTION OF THE DRAWINGS

Referring now to the figures, which are exemplary embodiments and wherein the like elements are numbered alike.

FIG. 1 is a side plan view of pliers comprising engaging surfaces upon which an active material is disposed that is capable of conforming to a surface of an object and/or undergoing a change in hardness or material stiffness for securing the object; and

FIG. 2 is a side plan view of a G-clamp comprising an engaging surface upon which an active material is disposed that is capable of conforming to a surface of an object and/or undergoing a change in hardness or material stiffness for securing the object.

### DETAILED DESCRIPTION

Clamping apparatuses can include: a clamp comprising an engaging surface for securing an object; and an active material disposed on the engaging surface that is capable of undergoing a change in a property upon exposure to an activation source such that the active material conforms to the surface of the object. This change in property of the active material can be reversed upon exposure to the activation source again. Moreover, it can be repeated multiple times if desired. Furthermore, in various embodiments, depending on the type of active material, it can experience either a decrease or an increase in its modulus as well as a shape memory effect upon the application or removal of an applied field, all of which can act to increase the grip between the gripping surface of the clamp and the object. As used herein, the term “active material” (also called “smart material”) refers to several different classes of material, all of which exhibit a change in at least one property, such as shape, dimension, geometry, flexural modulus, and stiffness, when exposed to at least one of many different types of activation sources. Examples of such activation sources include, but are not limited to, thermal, electrical, magnetic, and stress sources. The term “clamp” as used herein generally refers to any device capable of securing or holding an object in place. The active material can be applied to the engaging surfaces of currently used clamps or grips such as pliers, wrenches, vice grips, bench vices, G- or C-clamps, pipe clamps, etc.

The presence of the active material on one or more engaging surfaces of the clamping apparatus dramatically enhances the clamping/gripping capability thereof, particularly when the apparatus is a hand tool like those described above. Additionally, due to the conforming geometries of the engaging surfaces of the apparatus and the object being gripped, the normal load and thus surface damage to the gripped object can be minimized. Thus, due to the conforming geometries of the engaging surfaces and the resulting more uniform pressure distribution, a mechanical interlock can be formed between the clamping apparatus and the gripped object with reduced or even without deformation or indentation of the surface of the object.

Examples of suitable active materials include, but are not limited to, shape memory alloys (“SMAs”; e.g., thermal and stress activated shape memory alloys and magnetic shape memory alloys (MSMA)), electroactive polymers (EAPs) such as dielectric elastomers, piezoelectric materials (e.g., polymers, ceramics), and shape memory polymers (SMPs), shape memory ceramics (SMCs), baroplastics, magnetorheological (MR) elastomers, electrorheological (ER) elastomers, electrostrictives, magnetostrictives, composites of the foregoing active materials with non-active materials, systems comprising at least one of the foregoing active materials, and combinations comprising at least one of the foregoing active materials. For convenience and by way of example, reference herein will be made to shape memory alloys and shape memory polymers. MR and ER elastomers, shape memory ceramics, baroplastics, and the like, can be employed in a similar manner. For example, with baroplastic materials, a pressure induced mixing of nanophase domains of high and low glass transition temperature (Tg) components effects the shape change. Baroplastics can be processed at relatively low temperatures repeatedly without degradation. SMCs are similar to SMAs but can tolerate much higher operating temperatures than can other shape-memory materials. An example of an SMC is a piezoelectric material.

The ability of shape memory materials to return to their original shape upon the application or removal of external stimuli has led to their use in actuators to apply force resulting in desired motion. Active material actuators offer the potential for a reduction in actuator size, weight, volume, cost, noise and an increase in robustness in comparison with traditional electromechanical and hydraulic means of actuation. Ferromagnetic SMAs, for example, exhibit rapid dimensional changes of up to several percent in response to (and proportional to the strength of) an applied magnetic field. However, these changes are one-way changes and use the application of either a biasing force or a field reversal to return the ferromagnetic SMA to its starting configuration.

Shape memory alloys exhibit properties that are unique in that they are typically not found in other metals. In particular, they are alloy compositions with at least two different temperature-dependent phases or polarity. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as the austenite start temperature (As). The temperature at which this phenomenon is complete is often called the austenite finish temperature (Af). When the shape memory alloy is in the austenite phase and is cooled, it begins to change into the martensite phase, and the temperature at which this phenomenon starts is often referred to as the martensite start temperature (Ms). The temperature at which austenite finishes transforming to martensite is often called the martensite finish temperature (Mf). The range between As and Af is often referred to as the martensite-to-austenite transformation temperature range while that between Ms and Mf is often called the austenite-to-martensite transformation temperature range. It should be noted that the above-mentioned transition temperatures are functions of the stress experienced by the SMA sample. Generally, these temperatures increase with increasing stress. In view of the foregoing properties, deformation of the shape memory alloy is preferably at or below the austenite start temperature (at or below As). Subsequent heating above the austenite start temperature causes the deformed shape memory material sample to begin to revert back to its original (nonstressed) permanent shape until completion at the austenite finish temperature. Thus, a suitable activation source or signal for use with shape memory alloys is a thermal activation source/signal having a magnitude that is sufficient to cause transformations between the martensite and austenite phases. Some shape memory alloys exhibit a one-way shape memory effect in that after being heated to transform them to the Austenite phase, they do not return to their deformed shape when cooled to at or below As. Another advantage of shape memory alloys over other metals is their good resistance to corrosion.

The temperature at which the shape memory alloy remembers its high temperature form (i.e., its original, nonstressed shape) when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery over a wider temperature range. The start or finish of the transformation can be controlled to within several degrees depending on the desired application and alloy composition. The mechanical properties of the shape memory alloy vary greatly over the temperature range spanning their transformation, typically providing shape memory effect and superelastic effect. For example, in the martensite phase a lower elastic modulus than in the austenite phase is observed. Shape memory alloys in the martensite phase can undergo large deformations by realigning the crystal structure arrangement with the applied stress. The material will retain this shape after the stress is removed. In other words, stress induced phase changes in SMA are two way by nature, application of sufficient stress when an SMA is in its austenitic phase will cause it to change to its lower modulus Martensitic phase. Removal of the applied stress will cause the SMA to switch back to its Austenitic phase, and in so doing, recover its starting shape and higher modulus.

Exemplary shape memory alloy materials include, but are not limited to, nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, combinations comprising at least one of the foregoing alloys, and so forth. The alloys can be binary, ternary, or any higher order so long as the alloy composition exhibits a shape memory effect, e.g., change in shape, orientation, yield strength, flexural modulus, damping capacity, superelasticity, and/or similar properties. Selection of a suitable shape memory alloy composition depends, in part, on the temperature range of the intended application.

The recovery to the austenite phase at a higher temperature is accompanied by very large (compared to that needed to deform the material) stresses, which can be as high as the inherent yield strength of the austenite material, sometimes up to three or more times that of the deformed martensite phase. For applications that require a large number of operating cycles, a strain of less than or equal to about 4% can be obtained.

MSMAs are alloys; often composed of Ni—Mn—Ga, that change shape due to strain induced by a magnetic field. MSMAs have internal variants with different magnetic and crystallographic orientations. In a magnetic field, the proportions of these variants change, resulting in an overall shape change of the material. An MSMA actuator generally requires that the MSMA material be placed between coils of an electromagnet. Electric current running through the coil induces a magnetic field through the MSMA material, causing a change in shape.

As previously mentioned, other exemplary shape memory materials are shape memory polymers (SMPs). “Shape memory polymer” generally refers to a polymeric material, which exhibits a change in a property, such as a modulus, a dimension, a coefficient of thermal expansion, the permeability to moisture, an optical property (e.g., transmissivity), or a combination comprising at least one of the foregoing properties in combination with a change in its a microstructure and/or morphology upon application of an activation signal. Shape memory polymers can be thermoresponsive (i.e., the change in the property is caused by a thermal activation signal delivered either directly via heat supply or removal, or indirectly via a vibration of a frequency that is appropriate to excite high amplitude vibrations at the molecular level which lead to internal generation of heat), photoresponsive (i.e., the change in the property is caused by an electromagnetic radiation activation signal), moisture-responsive (i.e., the change in the property is caused by a liquid activation signal such as humidity, water vapor, or water), chemo-responsive (i.e. responsive to a change in the concentration of one or more chemical species in its environment; e.g., the concentration of H+ ion—the pH of the environment), or a combination comprising at least one of the foregoing.

Generally, SMPs are phase segregated co-polymers comprising at least two different units, which can be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment can be (semi-)crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n-1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be imparted a permanent shape. A permanent shape for the SMP can be set or memorized by subsequently cooling the SMP below that temperature. As used herein, the terms “original shape”, “previously defined shape”, “predetermined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it can be possible to demonstrate multiple permanent shapes. Similarly using a layered or composite approach, a combination of multiple SMPs can demonstrate transitions between multiple temporary and permanent shapes.

SMPs exhibit a dramatic drop in modulus when heated above the glass transition temperature of that of their constituent that has a lower glass transition temperature. If loading/deformation is maintained while the temperature is dropped, the deformed shape can be set in the SMP until it is reheated while under no load to return to its as-molded original shape.

The active material can also comprise a piezoelectric material. Also, in certain embodiments, the piezoelectric material can be configured as an actuator for providing rapid activation. As used herein, the term “piezoelectric” is used to describe a material that mechanically deforms (changes shape) when a voltage potential is applied, or conversely, generates an electrical charge when mechanically deformed. Piezoelectrics exhibit a small change in dimensions when subjected to the applied voltage, with the response being proportional to the strength of the applied field and being quite fast (capable of easily reaching the thousand hertz range). Because their dimensional change is small (e.g., less than 0.1%), to dramatically increase the magnitude of dimensional change they are usually used in the form of piezo ceramic or piezo polymer unimorph and bi-morph flat strip actuators, which are constructed so as to bow into a concave or convex shape or twist upon application of a relatively small voltage.

One type of unimorph is a structure composed of a single piezoelectric element externally bonded to a flexible metal foil or strip, which is stimulated by the piezoelectric element when activated with a changing voltage and results in an axial buckling or deflection as it opposes the movement of the piezoelectric element. The actuator movement for a unimorph can be by contraction or expansion. Unimorphs can exhibit a strain of as high as about 10%, but generally can only sustain low loads relative to the overall dimensions of the unimorph structure.

In contrast to the unimorph piezoelectric device, a bimorph device includes an intermediate flexible metal band sandwiched between two piezoelectric elements. Bimorphs exhibit more displacement than unimorphs because under the applied voltage one ceramic element will contract while the other expands. Bimorphs can exhibit strains up to about 20%, but similar to unimorphs, generally cannot sustain high loads relative to the overall dimensions of the unimorph structure.

Exemplary piezoelectric materials include inorganic compounds, organic compounds, and metals. With regard to organic materials, all of the polymeric materials with noncentrosymmetric structure and large dipole moment group(s) on the main chain or on the side-chain, or on both chains within the molecules, can be used as candidates for the piezoelectric film. Examples of suitable polymers include, but are not limited to, poly(sodium 4-styrenesulfonate) (“PSS”), poly S-119 (Poly(vinylamine) backbone azo chromophore), and their derivatives; polyfluorocarbines, including polyvinylidene fluoride (“PVDF”), its co-polymer vinylidene fluoride (“VDF”), trifluorethylene (TrFE), and their derivatives; polychlorocarbons, including poly(vinylchloride) (“PVC”), polyvinylidene chloride (“PVC2”), and their derivatives; polyacrylonitriles (“PAN”) and their derivatives; polycarboxylic acids, including poly (methacrylic acid (“PMA”), and their derivatives; polyureas and their derivatives; polyurethanes (“PUE”) and their derivatives; bio-polymer molecules such as poly-L-lactic acids and their derivatives, and membrane proteins, as well as phosphate bio-molecules; polyanilines and their derivatives, and all of the derivatives of tetraamines; polyimides, including Kapton® molecules and polyetherimide (“PEI”), and their derivatives; all of the membrane polymers; poly (N-vinyl pyrrolidone) (“PVP”) homopolymer and its derivatives and random PVP-co-vinyl acetate (“PVAc”) copolymers; all of the aromatic polymers with dipole moment groups in the main-chain or side-chains, or in both the main-chain and the side-chains; and combinations comprising at least one of the foregoing.

Further piezoelectric materials can include Pt, Pd, Ni, T, Cr, Fe, Ag, Au, Cu, and metal alloys comprising at least one of the foregoing, as well as combinations comprising at least one of the foregoing. These piezoelectric materials can also include, for example, metal oxides such as SiO₂, Al₂O₃, ZrO₂, TiO₂, SrTiO₃, PbTiO₃, BaTiO₃, FeO₃, Fe₃O₄, ZnO, and combinations comprising at least one of the foregoing; and Group VIA and IIB compounds such as CdSe, CdS, GaAs, AgCaSe₂, ZnSe, GaP, InP, ZnS, and combinations comprising at least one of the foregoing.

Exemplary shape memory materials also comprise magnetorheological (MR) and ER polymers. MR polymers are suspensions of micrometer-sized, magnetically polarizable particles (e.g., ferromagnetic or paramagnetic particles as described below) in a polymer (e.g., a thermoset elastic polymer or rubber). Exemplary polymer matrices include, but are not limited to, poly-alpha-olefins, natural rubber, silicone, polybutadiene, polyethylene, polyisoprene, and combinations comprising at least one of the foregoing.

The stiffness and potentially the shape of the polymer structure are attained by changing the shear and compression/tension moduli by varying the strength of the applied magnetic field. The MR polymers typically develop their structure when exposed to a magnetic field in as little as a few milliseconds, with the stiffness and shape changes being proportional to the strength of the applied field. Discontinuing the exposure of the MR polymers to the magnetic field reverses the process and the elastomer returns to its lower modulus state. Packaging of the coils for generating the applied field, however, creates challenges.

Suitable particles include, but are not limited to, iron; iron oxides (including Fe₂O₃ and Fe₃O₄); iron nitride; iron carbide; carbonyl iron; nickel; cobalt; chromium dioxide; and combinations comprising at least one of the foregoing; e.g., nickel alloys; cobalt alloys; iron alloys such as stainless steel, silicon steel, as well as others including aluminum, silicon, cobalt, nickel, vanadium, molybdenum, chromium, tungsten, manganese and/or copper. The particle size can be selected so that the particles exhibit multiple magnetic domain characteristics when subjected to a magnetic field. Particle diameters (e.g., as measured along a major axis of the particle) can be less than or equal to about 1,000 micrometers (μm) (e.g., about 0.1 micrometer to about 1,000 micrometers), specifically about 0.5 to about 500 micrometers, or more specifically about 10 to about 100 micrometers.

Electronic electroactive polymers (EAPs) are a laminate of a pair of electrodes with an intermediate layer of low elastic modulus dielectric material. Applying a potential between the electrodes squeezes the intermediate layer causing it to expand in plane. They exhibit a response proportional to the magnitude of the applied field and can be actuated at high frequencies.

Electroactive polymers include those polymeric materials that exhibit piezoelectric, pyroelectric, or electrostrictive properties in response to electrical or mechanical fields. An example of an electroactive polymer is an electrostrictive-grafted elastomer with a piezoelectric poly(vinylidene fluoride-trifluoro-ethylene) copolymer. This combination has the ability to produce a varied amount of ferroelectric-electrostrictive molecular composite systems.

Materials suitable for use as an electroactive polymer may include any substantially insulating polymer and/or rubber that deforms in response to an electrostatic force or whose deformation results in a change in electric field. Exemplary materials suitable for use as a pre-strained polymer include, but are not limited to, silicone elastomers, acrylic elastomers, polyurethanes, thermoplastic elastomers, copolymers comprising PVDF, pressure-sensitive adhesives, fluoroelastomers, polymers comprising silicone and acrylic moieties (e.g., copolymers comprising silicone and acrylic moieties, polymer blends comprising a silicone elastomer and an acrylic elastomer, and so forth), and combinations comprising at least one of the foregoing polymers.

Materials used as an electroactive polymer can be selected based on desired material propert(ies) such as a high electrical breakdown strength, a low modulus of elasticity (e.g., for large or small deformations), a high dielectric constant, and so forth. In one embodiment, the polymer can be selected such that is has an elastic modulus of less than or equal to about 100 MPa. In another embodiment, the polymer can be selected such that is has a maximum actuation pressure of about 0.05 megaPascals (MPa) to about 10 MPa, or more specifically about 0.3 MPa to about 3 MPa. In another embodiment, the polymer can be selected such that is has a dielectric constant of about 2 to about 20, or more specifically about 2.5 and to about 12. The present disclosure is not intended to be limited to these ranges. Ideally, materials with a higher dielectric constant than the ranges given above would be desirable if the materials had both a high dielectric constant and a high dielectric strength. In many cases, electroactive polymers can be fabricated and implemented as thin films, e.g., having a thickness of less than or equal to about 50 micrometers.

Electroactive polymers can deflect at high strains, and electrodes attached to the polymers can also deflect without compromising mechanical or electrical performance. Generally, electrodes suitable for use can be of any shape and material provided that they are able to supply a suitable voltage to, or receive a suitable voltage from, an electroactive polymer. The voltage can be either constant or varying over time. In one embodiment, the electrodes adhere to a surface of the polymer. Electrodes adhering to the polymer can be compliant and conform to the changing shape of the polymer. The electrodes can be only applied to a portion of an electroactive polymer and define an active area according to their geometry. Various types of electrodes include structured electrodes comprising metal traces and charge distribution layers, textured electrodes comprising varying out of plane dimensions, conductive greases (such as carbon greases and silver greases), colloidal suspensions, high aspect ratio conductive materials (such as carbon fibrils and carbon nanotubes, and mixtures of ionically conductive materials), as well as combinations comprising at least one of the foregoing.

Exemplary electrode materials can include, but are not limited to, graphite, carbon black, colloidal suspensions, metals (including silver and gold), filled gels and polymers (e.g., silver filled and carbon filled gels and polymers), ionically or electronically conductive polymers, and combinations comprising at least one of the foregoing. It is understood that certain electrode materials can work well with particular polymers but not as well with others. By way of example, carbon fibrils work well with acrylic elastomer polymers while not as well with silicone polymers.

Electrostrictives are dielectrics that produce a change of shape or mechanical deformation under the application of an electric field. Reversal of the electric field does not reverse the direction of the deformation. When an electric field is applied to an electrostrictive, it develops polarization(s). It then deforms, with the strain being proportional to the square of the polarization.

Magnetostrictives are solids that develop a mechanical deformation when subjected to an external magnetic field. This magnetostriction phenomenon is attributed to the rotations of small magnetic domains in the materials, which are randomly oriented when the material is not exposed to a magnetic field. The shape change is largest in ferromagnetic or ferromagnetic solids. These materials possess a very fast response capability, with the strain proportional to the strength of the applied magnetic field, and they return to their starting dimension upon removal of the field. However, these materials have maximum strains of about 0.1 to about 0.2 percent.

In accordance with an embodiment, a clamping apparatus includes a clamp comprising one or more engaging surfaces upon which an SMP is disposed. The SMP can comprise the entirety of the engaging surface. It can also be attached to the engaging surface by various means, including but not limited to adhesives, molding, or mechanical interlock (such as pre-heating and then pressing the SMP against the surface so as to engage, for example, protrusions on one surface with cavities of matching geometry on the other). The clamping apparatus can be utilized to secure an object by subjecting the SMP to a heat source (e.g., hot air, hot liquids, or resistive heating of embedded wires) to increase the temperature of the SMP to above its lower phase Tg. As a result, the stiffness of the SMP decreases such that it experiences a dramatic lowering of its elastic modulus, i.e. it softens. The clamping apparatus can then be adjusted such that its engaging surfaces engage or close upon the object being secured, thereby causing the contact area of the SMP to expand and intimately conform to the adjacent surface of the object. While maintaining the clamping apparatus in a closed position, the SMP can be cooled below its lower phase Tg to cause its stiffness to increase dramatically such that it becomes very hard and forms a mechanical interlock with the adjacent surface of the object. Due to this hardening of the SMP and the conforming geometries at the interface of the SMP and the object, the resistance to release through shear at that interface is significantly increased.

Therefore, the presence of the SMP in the clamp can significantly enhance the ability of the clamping apparatus to secure objects while at the same time decreasing the maximum local pressure between the engaging surface and the object. That is, SMP serves to reduce any deformation or indentation of the gripped object that might have otherwise been caused by gripping of the object. Furthermore, it is to be emphasized that for SMP, once in conformance (enabled at low force by the SMP being in its high temperature soft state) with the object being clamped, its modulus can be increased (by cooling) to thereby increase the strength of the grip/hold on the object without increasing the normal forces (squeezing forces) being exerted on the object.

When desired, the clamping apparatus comprising the SMP can be adjusted to remove the pressure applied to an object such that it releases the object (this release can include softening of the SMP). When the clamping apparatus no longer engages the object, the SMP can be reheated above its lower phase Tg to return it to its original geometry. The foregoing method of using the clamping apparatus can be repeated multiple times with conformance to a different object geometry each time.

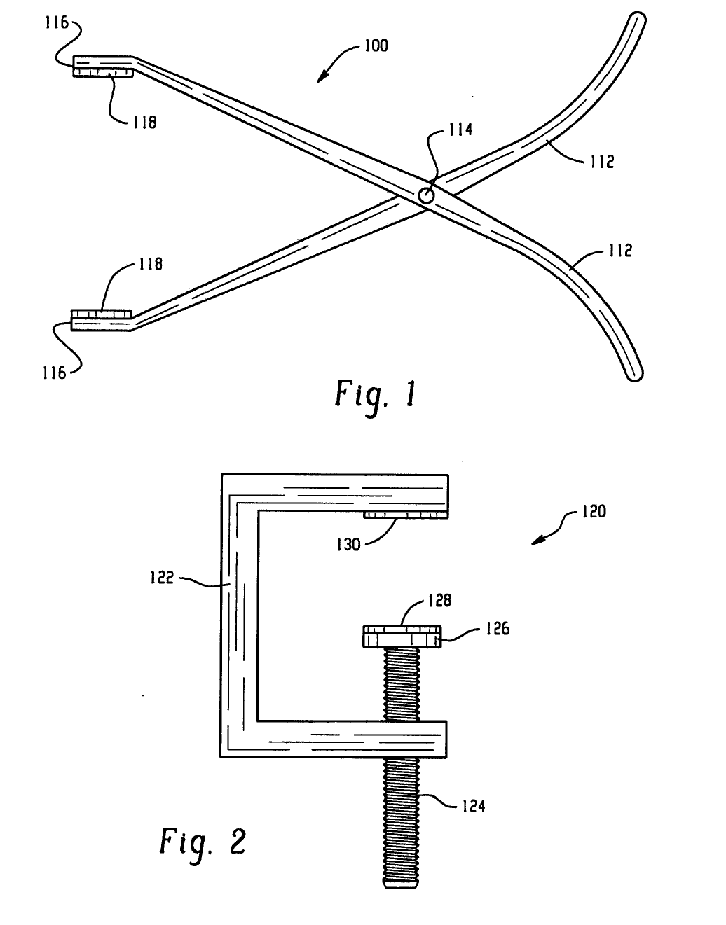

FIG. 1 illustrates an exemplary embodiment of a clamping apparatus in the form of pliers 100 that include two intersecting members 112 rotably attached about a pin 114. The pliers 100 have engaging ends 116 configured parallel to each other. An active material 118 such as a SMP can be disposed upon the engaging surfaces of engaging ends 116. Pressure can be applied to move the other ends of the members 112 closer together, thereby causing the engaging ends 116 to close upon and grip an object. The geometry of the active material 118 can conform to the geometry of the surface of the gripped object in response to being exposed to an activation source such as heat, thereby improving the ability of the pliers 100 to secure the gripped object.

FIG. 2 illustrates another embodiment of a clamping apparatus in the form of a G-clamp 120. The G-clamp 120 includes a rectangular-shaped ring 122 having an open side and a screw 124 extending through a hole in the lower end of the ring 122. The screw 124 and the hole in the ring 122 are threaded to mate with each other, allowing the screw 124 to be raised and lowered via rotation to engage and release an object. A perpendicularly arranged member 126 can be attached to the upper end of the screw 124 that includes an engaging surface 128. The G-clamp 120 can include another engaging surface 130 at the top of the ring 122 that faces the engaging surface 128. An active material that functions in the manner described above can be disposed upon the opposed engaging surfaces 128 and 130 of the G-clamp 120.

In an additional embodiment, a clamping apparatus includes a clamp comprising an SMA on or proximate to an engaging surface of the clamp. For SMA, once in conformance with what is being clamped (achieved by applying force to the clamping mechanism with the SMA in its lower modulus martensite phase), its modulus can be increased (by heating the SMA to its high temperature Austenite phase) so that, for example, in the case of a vice grip it clamps down on the object with higher force levels than originally set by the manual action of the user (and actually could exceed the upper limit of what the user could manually achieve). This latter also holds for MR polymers where the mechanism to increase stiffness and clamping force after initial conformance is the application of a magnetic field.

Another way in which an SMA can be used to increase conformity of the engaging and object surfaces and thus enhance gripping is through the stress activated superelastic effect. Starting with the SMA at its high temperature high modulus state, by applying pressure to the grip, the SMA can, under stress, switch to its lower modulus Martensitic phase and in so doing deform and more closely conform to the surface geometry of the object being gripped. The superelastic effect causes the SMA to strive to return to its original undeformed shape and thus assists in maintaining proximity and conformance between the engaging and object surfaces and causes the SMA to return to its starting geometry once the grip is released.

As used herein, the terms “a” and “an” do not denote a limitation of quantity, but rather denote the presence of at least one of the referenced items. Reference throughout the specification to “one embodiment”, “another embodiment”, “an embodiment”, and so forth means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. Unless defined otherwise, technical and scientific terms used herein have the same meaning as is commonly understood by one of skill in the art to which this invention belongs.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A clamping apparatus for securing an object, comprising: a clamp comprising an engaging surface for securing an object, wherein the engaging surface comprises an active material capable of undergoing a change in a property upon exposure to an activation source such that the active material conforms to a surface of the object.

2. The clamping apparatus of claim 1, wherein the change in the property is capable of reversing upon exposure to the activation source.

3. The clamping apparatus of claim 1, wherein the clamp is selected from the group consisting of pliers, a wrench, a vice grip, a bench vice, a C-clamp, a G-clamp, and a pipe clamp.

4. The clamping apparatus of claim 1, wherein the active material comprises a shape memory alloy, an electroactive polymer, a piezoelectric material, a shape memory polymer, a shape memory ceramic, a baroplastic, a magnetorheological material, an electrorheological material, an electrostrictive material, a magnetostrictive material, a composite of at least one of the foregoing active materials with a non-active material, and a combination comprising at least one of the foregoing active materials.

5. The clamping apparatus of claim 1, wherein the property of the active material is a shape, a dimension, a geometry, a flexural modulus, a stiffness, or a combination comprising at least one of the foregoing properties.

6. The clamping apparatus of claim 1, wherein the active material comprises a shape memory polymer (SMP) that decreases in stiffness when heated above a lower phase glass transition temperature of the SMP such that the SMP, when loaded against an object, conforms to the surface of the object, and wherein the SMP increases in stiffness upon cooling below the lower phase glass transition temperature such that the clamp is secured to the object.

7. The clamping apparatus of claim 6, wherein the SMP returns to its original geometry when re-heated above the lower phase glass transition temperature to allow the clamping apparatus to be used to secure another object.

8. The clamping apparatus of claim 1, wherein the active material comprises a shape memory alloy that switches to the Martensitic phase when loaded against the object by application of a force such that the active material conforms to the surface of the object

9. The clamping apparatus of claim 8, wherein the shape memory alloy returns to its original geometry when the force is released.

10. A method of forming a clamping apparatus for securing an object, comprising: applying an active material to an engaging surface of a clamp, wherein the active material is capable of undergoing a change in a property upon exposure to an activation source such that the active material conforms to the surface of the object.

11. The method of claim 10, wherein the change in the property is capable of reversing upon exposure to the activation source.

12. The method of claim 10, wherein the clamp is selected from the group consisting of pliers, a wrench, a vice grip, a bench vice, a C-clamp, a G-clamp, and a pipe clamp.

13. The method of claim 10, wherein the active material comprises a shape memory alloy, an electroactive polymer, a piezoelectric material, a shape memory polymer, a shape memory ceramic, a baroplastic, a magnetorheological material, an electrorheological material, an electrostrictive material, a magnetostrictive material, a composite of at least one of the foregoing active materials with a non-active material, and a combination comprising at least one of the foregoing active materials.

14. The method of claim 10, wherein the property of the active material is a shape, a dimension, a geometry, a flexural modulus, a stiffness, or a combination comprising at least one of the foregoing properties.

15. The method of claim 10, wherein the activation source is a heat source.

16. The method of claim 10, wherein the active material comprises a shape memory polymer (SMP) that decreases in stiffness when heated above a lower phase glass transition temperature of the SMP such that the SMP when loaded against an object conforms to the surface of the object, and wherein the SMP increases in stiffness upon cooling below the lower phase glass transition temperature such that the clamp is secured to the object.

17. The method of claim 16, wherein the SMP returns to its original geometry when re-heated above the lower phase glass transition temperature to allow the clamping apparatus to be used to secure another object.

18. The method of claim 10, wherein the active material comprises a shape memory alloy that switches to the Martensitic phase when loaded against the object by application of a force such that the active material conforms to the surface of the object, and wherein the shape memory alloy returns to its original geometry when the force is released.

19. A clamping apparatus for securing an object, comprising: a clamp comprising an engaging surface for securing an object, wherein the engaging surface comprises an active material capable of conforming to a surface of the object and undergoing an increase in hardness or stiffness upon exposure to an activation source such that the hold of the grip on the object is increased.

20. The clamping apparatus of claim 19, wherein the active material comprises a shape memory alloy with the activation source being a heat source, a shape memory polymer with the activation source being a cooling source, a magnetorheological plastic with the activation source being a magnetic field, or a combination comprising at least one of the foregoing.
